(19) United States
(12) Patent Application Publication
(10) Pub. No.: US 2013/0301185 A1
(43) Pub. Date: Nov. 14, 2013

(54) MULTILAYERED CERAMIC ELEMENTS

(71) Applicant: SAMSUNG ELECTRO-MECHANICS CO., LTD., Suwon-si (KR)

(72) Inventors: Seung Ho LEE, Suwon-si (JP); Jong Han KIM, Suwon-si (KR); Eung Soo KIM, Gyunggi-Do (KR)

(73) Assignee: SAMSUNG ELECTRO-MECHANICS CO., LTD., Suwon-si (KR)

(21) Appl. No.: 13/890,108

(22) Filed: May 8, 2013

(30) Foreign Application Priority Data
May 8, 2012 (KR) 10-2012-0048609

(51) Int. Cl. H01G 4/30

(52) U.S. Cl. CPC H01G 4/30
USPC 361/301.4

(57) ABSTRACT

Disclose herein are multilayered ceramic elements having a structure in which an inner electrode layer and a dielectric layer are alternately multilayered, wherein the inner electrode layer may include inhibitors in the amount of 3 to 12 wt % with respect to a weight of metal powders, and an average particle size of the inhibitors may have a size of about 30% with respect to an average particle size of dielectric base metals. According to the exemplary embodiments of the present invention, it is possible to manufacture the elements with excellent reliability by increasing the capacity of the multilayered ceramic elements by controlling the particle size and the added quantity of the inhibitors included in the inner electrode layers that is squeezed out during firing at high temperature.

### CROSS REFERENCE(S) TO RELATED APPLICATIONS

This application claims the benefit under 35 U.S.C. Section 119 of Korean Patent Application Serial No. 10-2012-0048609, entitled “Multilayered Ceramic Elements” filed on May 8, 2012, which is hereby incorporated by reference in its entirety into this application.

### BACKGROUND OF THE INVENTION

1. Technical Field

The present invention relates to multilayered ceramic elements with excellent capacity characteristic and high reliability.

2. Description of the Related Art

A multilayered ceramic capacitor (hereinafter, referred to as MLCC) is manufactured by forming an electrode layer by printing conductive paste on a formed dielectric layer sheet using screen, gravure, and the like, so as to print inner electrode layers and multilayering sheets on which the inner electrode layers are printed.

In this case, the used conductive paste is formed of metal powders such as nickel (Ni), copper (Cu), and the like, inorganic matters such as ceramic powders (inhibitors), and the like, and organic matters such as a dispersant, resin, additives, a solvent, and the like.

Generally, the metal powders, such as Ni, Cu, and the like, that are used for inner electrode paste have a melting point lower than the ceramic powder used for the dielectric layers and therefore, the temperature at which sintering shrinkage starts is lower. Therefore, the ceramic powders, and the like, used as the inhibitors are added and move at high temperature so as to make a shrinkage starting temperature similar to that of the dielectric and the ceramic powders used as the inhibitors during a process of firing the inner electrode layers are absorbed into the dielectric layers and therefore, finally contributes to dielectric characteristics, such that they are designed as the same or similar composition as the dielectric layers. In a general case, barium titanate (BaTiO₃) having the same components as those of the dielectric layers is used as main components as the inhibitors and in order to further increase the sintering starting temperature, various kinds of oxide-based accessory components are also used.

In the manufacturing of the MLCC, the inner electrodes are sintered by the following process.

The process includes (1) discharging the inhibitors while shrinking the metal powders at 800 to 1000° C., (2) connecting the inner electrode layers with each other while shrinking the dielectric layers at 1000 to 1100° C., and (3) agglomerating the inner electrode layers while densifying the dielectric layers at 1100° C. or more. Therefore, as the sintering temperature is increased, the breakage of electrodes is increased. As the use of particulate metal powders is used for thinning, the breakage of electrodes is further increased.

Recently, as a demand for miniaturized and multi-functional electronic products is increased, a demand for the miniaturized and high-capacity MLCC embedded in the electronic products is increased. In order to implement the miniaturized and high-capacity MLCC, a method for reducing a thickness of the dielectric layers interposed between the inner electrode layers in a ceramic body or increasing the number of multilayered inner electrode layers is used. However, when the thickness of the dielectric layer is reduced, there is a limitation in that reliability of the MLCC may be degraded.

Therefore, there is a need to develop the multilayered ceramic elements capable of maintaining reliability while increasing capacity.

### PRIOR ART DOCUMENT

### Patent Document

(Patent Document 1) Japanese Patent Laid-Open Publication No. 2006-086400

### SUMMARY OF THE INVENTION

An object of the present invention is to provide multilayered ceramic elements with various structures capable of maximizing capacity while maintaining high reliability by controlling a content or a size of inhibitors added to the inner electrode layers.

According to an exemplary embodiment of the present invention, there is provided multilayered ceramic elements having a structure in which an inner electrode layer and a dielectric layer are alternately multilayered, wherein the inner electrode layer may include inhibitors in the amount of 3 to 12 wt % with respect to a weight of metal powders, and an average particle size of the inhibitors may have a size of about 30% with respect to an average particle size of dielectric base metals included in the dielectric layer.

According to another exemplary embodiment of the present invention, there is provided multilayered ceramic elements having a structure in which an inner electrode layer and a dielectric layer are alternately multilayered, wherein the inner electrode layer may include inhibitors in the amount of 3 to 12 wt % with respect to a weight of metal powders, an average particle size of the inhibitors may have a size of about 30% with respect to an average particle size of dielectric base metals included in the dielectric layer, and dielectric grains of the dielectric layer may have a laminar structure.

According to still another exemplary embodiment of the present invention, there is provided multilayered ceramic elements having a structure in which an inner electrode layer and a dielectric layer are alternately multilayered, wherein the inner electrode layer may include inhibitors in the amount of 3 to 12 wt % with respect to a weight of metal powders, an average particle size of the inhibitors may have a size of about 30% with respect to an average particle size of dielectric base metals included in the dielectric layer, dielectric grains of the dielectric layer may have a laminar structure, and sizes of the dielectric grains may be different from each other after and before being sintered.

The size of the dielectric grains after being sintered may be 1 to 1.3 times larger than the size of the dielectric grains before being sintered.

According to still yet another exemplary embodiment of the present invention, there is provided multilayered ceramic elements having a structure in which an inner electrode layer and a dielectric layer are alternately multilayered, wherein the inner electrode layer may include inhibitors in the amount of 3 to 12 wt % with respect to a weight of metal powders, an average particle size of the inhibitors may have a size of about 30% with respect to an average particle size of dielectric base metals, dielectric grains of the dielectric layer may have a laminar structure, and in a dielectric grain having the laminar structure, an average particle size D (interface) of the dielectric grain positioned at an interface adjacent to an inner electrode may be larger than an average grain size D (inner) of the dielectric grain positioned in the dielectric layer in which the dielectric grains are adjacent to each other, rather than being adjacent to the inner electrode.

The D (interface)/D (inner) may satisfy 1.2 to 2.2.

The average particle size of the dielectric grain may be 0.15 μm or less.

A thickness of the dielectric layer may be 0.5 μm or less.

The dielectric layer may have a laminar structure of 3 to 7 layers.

The dielectric grains may be adjacent to each other in other shapes other than a spherical shape.

The inner electrode layer may have a thickness of 0.1 to 0.5 μm.

The inner electrode may be made of nickel (Ni) or copper (Cu).

The inhibitors may include barium titanate (BaTiO₃) and metal oxides.

Metals of the metal oxides may be one or more lanthanide rare earth elements selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺.

### BRIEF DESCRIPTION OF THE DRAWINGS

FIG. 1 is a diagram showing a partial structure of a cross section of a multilayered ceramic element according to an embodiment of the present invention.

FIG. 2 is a diagram showing a partial structure of a multilayered ceramic element according to a second embodiment of the present invention.

FIG. 3 is a diagram showing a partial structure of a multilayered ceramic element according to a fourth embodiment of the present invention.

FIG. 4 is a diagram showing a grain structure of a dielectric layer in the multilayered ceramic elements according to the embodiment of the present invention.

### DESCRIPTION OF THE PREFERRED EMBODIMENTS

Hereinafter, exemplary embodiments of the present invention will be described in detail with reference to the accompanying drawings.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, numerals, operations and/or elements but not the exclusion of any other constituents, steps, operations and/or elements.

The present invention relates to high-capacity, high-reliability multilayered ceramic elements.

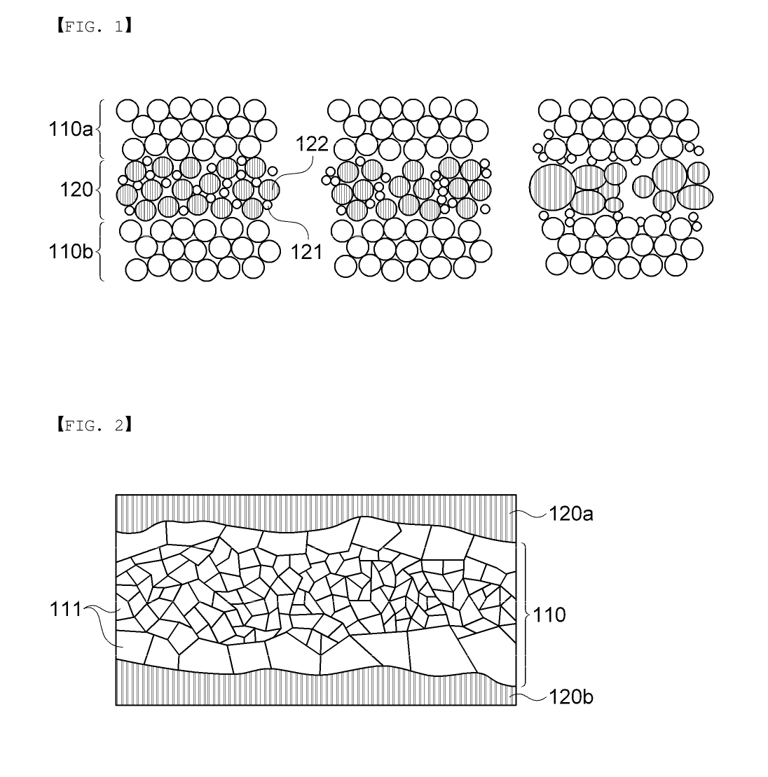

Next, FIG. 1 shows a role of general inhibitors in manufacturing an MLCC that is multilayered electronic elements. Referring to FIG. 1, when a dielectric sheet having an inner electrode layer 120 formed between dielectric layers 110a and 110b is sintered, inhibitors 121 included in the inner electrode layer 120 serve to their own role by suppressing shrinkage starting of metal nickel powders 122 used as metal powders of the inner electrode layer 120.

(2) Next, necking of the metal nickel powders 122 starts while the shrinkage of the metal nickel powders 122 starts at 700 to 900° C. to agglomerate the metal nickel powders 122 and the inhibitors 121.

(3) Finally, the inhibitors 121 are discharged from the inner electrode layer 120 at 900° C. or more and thus, move and absorb into the dielectric layers 110a and 110b or a separate inhibitor accumulated layer is also generated. The dielectric layers 110a and 110b starts to be sintered and reacts to the inhibitors introduced from the inner electrode layer 120. Therefore, compositions of the inhibitors affect characteristics of the dielectric layers.

The multilayered ceramic elements according to a first exemplary embodiment of the present invention include the metal powder as the inner electrode layer and the inhibitors in the amount of 3 to 12 wt % with respect to a weight of the metal powders in a structure in which the inner electrode layer and the dielectric layer are alternately multilayered, wherein an average particle size of the inhibitors has a size of about 30% with respect to an average particle size of dielectric base metals included in the dielectric layer.

The “inhibitors” used herein is used together with the metal powders in the inner electrode layer, which means a material serving to delay firing temperature of the metal powders.

The first exemplary embodiment of the present invention is to maximize the capacity of the multilayered ceramic elements by controlling the content and particle size of the included inhibitors in order to delay the sintering of the inner electrode layer.

The inner electrode layer includes the metal powders used as an inner electrode and inhibitors as a sintering inhibitor, wherein the inhibitors are preferably included at a content of 3 to 12 wt % with respect to a weight of the metal powders. An effect of increasing capacity is weak when the content of the inhibitors is less than 3 wt % with respect to the weight of the metal powder. In addition, when the content of the inhibitors exceeds 12 wt %, the inhibitors are discharged to the dielectric layer when being sintered and thus, the thickness of the dielectric layer is excessively grown to reduce capacity. Therefore, these two cases are not preferable.

In addition, the average particle size of the inhibitors has a size of about 30%, preferably, a size of 10 to 25% with respect to the average particle size of the dielectric base metals included in the dielectric layer.

When the average particle size of the inhibitors has a size exceeding 30% with respect to the average particle size of the dielectric base metals included in the dielectric layer, a small amount of added inhibitors cannot control the inner electrode sintering shrinkage behavior, thereby degrading the reliability.

Generally, the inhibitors use the same components as barium titanate (BaTiO₃) configuring the dielectric layer to serve to move the shrinkage starting temperature of the metal powders to high temperature as maximally as possible in the inner electrode layer and are generally absorbed into the dielectric layers during the process of firing the inner electrodes.

The inhibitors of the present invention use as the main component the barium titanate (BaTiO₃) that is the same material as the dielectric layers and use a mixture of metal oxides as accessory components. An example of metals of the metal oxides may include one or more lanthanide rare earth elements selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺.

However, the capacity characteristics can be improved by differently controlling the average particle sizes of the dielectric base metals used in the dielectric layers. Therefore, it is preferable to use the inhibitors having the average particle size of the inhibitors of about 30% with respect to the average particle size of the dielectric base metals included in the dielectric layers.

The metal powders of the inner electrode layer preferably use nickel (Ni) or copper (Cu) and the inner electrode layer preferably has a thickness of 0.1 to 0.5 μm.

In addition, as shown in FIG. 2, multilayered ceramic elements according to a second exemplary embodiment of the present invention have a structure in which the inner electrode layers 120a and 120b and the dielectric layer 110 are alternately multilayered, wherein the inner electrode layers 120a and 120b include the inhibitors in the amount of 3 to 12 wt % with respect to the weight of the metal powders, the average particle size of the inhibitors has a size of about 30% with respect to the average particle size of the dielectric base metals included in the dielectric layer 110, and the dielectric grains 111 of the dielectric layer 110 has a laminar structure.

According to the second exemplary embodiment of the present invention, as shown in FIG. 2, the dielectric grains 111 configuring the dielectric layers 110 have the laminar structure by controlling the content and particle size of the inhibitors.

The exemplary embodiment of the present invention indicates that the thickness of the dielectric layer 110 is about 0.5 μm or less. When the thickness of the dielectric layer 110 exceeds 0.5 μm, the dielectric layer becomes too thick, which is not preferable since a large number of layers need to be formed. Therefore, in the exemplary embodiment of the present invention, the dielectric layer 110 is formed to be thin, but the dielectric grains 111 configuring the same may have the multi-layer laminar structure. As shown in FIG. 2, it can be appreciated that the dielectric layer 110 of the exemplary embodiment of the present invention is formed so that the dielectric grains 111 has a structure of two layers or more, preferably, 3 to 7 layers. The dielectric grains 111 have the multi-layer laminar structure, thereby improving the reliability characteristics of the multilayered ceramic elements.

In addition, as shown in FIG. 2, the dielectric grains 111 configuring the dielectric layer 110 may be adjacent to each other in shapes other than a spherical shape, for example, a polygon, a diamond, a rectangle, a regular square, a triangle, a square, and the like. The shape of the dielectric grains 111 may use all the shapes other than the spherical shape having a round shape.

The average particle size of the dielectric grain 111 configuring the dielectric layer 110 is preferably 0.15 μm or less. When the average particle size of the dielectric grain 111 exceeds 0.15 μm, it is difficult to manufacture a super-capacity chip due to the formation of the thick dielectric layer in order to increase breakdown voltage (BDV) of the multilayered ceramic element chips.

The structural characteristics of the dielectric layer 110 can be achieved by appropriately controlling the content and particle size of the inhibitors used in the inner electrode layer. Therefore, the inner electrode layers 120a and 120b include the inhibitors in the amount of 3 to 12 wt % with respect to the weight of the metal powders, wherein the average particle size of the inhibitors has the size of about 30% with respect to the average particle size of the dielectric base metals included in the dielectric layer 110.

Therefore, in the case in which the inhibitors according to the exemplary embodiment of the present invention is less than 3 wt % with respect to the weight of the metal powder, the inhibitors are insufficient to have the multi-layer structure. In addition, when the inhibitors exceeds 12 wt %, the dielectric grains positioned at the interface between the dielectric layer and the inner electrode layer are excessively grown or the thick dielectric layer is formed to degrade the reliability and capacity, and the like, thereby causing the problem of implementing the chip characteristics.

In addition, when the average particle size of the inhibitors exceeds 30% with respect to the average particle size of the dielectric base metals included in the dielectric layer, it is not possible to control the shrinkage of the electrode with a small amount of inhibitors and thus, it is difficult to implement the high reliability.

As the dielectric components configuring the dielectric layer according to the second exemplary embodiment of the present invention, the barium titanate (BaTiO₃) may be used like the first exemplary embodiment of the present invention, as the metal powders of the inner electrode layer, nickel (Ni) or copper (Cu) may be used, and the inner electrode layer may have a thickness of 0.1 to 0.5 μm.

In addition, the inhibitors use the barium titanate (BaTiO₃) as main components and use a mixture of metal oxides as accessory components. An example of metals of the metal oxides may include one or more lanthanide rare earth elements selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺.

In addition, the multilayered ceramic elements according to a third exemplary embodiment of the present invention include a structure in which the inner electrode layer and the dielectric layer are alternately multilayered, wherein the inner electrode layer includes the inhibitors in the amount of 3 to 12 wt % with respect to the weight of the metal powders, the average particle size of the inhibitors has a size of about 30% with respect to the average particle size of the dielectric base metals included in the dielectric layer, the dielectric grains of the dielectric layers have the laminar structure, and the sizes of the dielectric grains are different from each other after and before being sintered.

According to the third exemplary embodiment of the present invention, the dielectric grains configuring the dielectric layers have a multi-layer, for example, two layers or more, preferably, the laminar structure of 3 to 7 layers by controlling the content and particle size of the inhibitors, but the dielectric grains are formed to be largely after being sintered than before being sintered.

Even in the third exemplary embodiment of the present invention, the thin dielectric layer is formed to have a thickness of 0.5 μm or less and the dielectric grains configuring the dielectric layer may have a multi-layer laminar structure. The dielectric grains 111 have the multi-layer laminar structure, thereby improving the reliability characteristics (BDV, acceleration lifespan, and the like) of the multilayered ceramic elements.

In particular, the size of the dielectric grains of the dielectric layer of the present invention is a larger, after being sintered than before being sintered. The effect can be achieved by appropriately controlling the content and particle size of the inhibitors included in the inner electrode layer. In detail, the inhibitors included in the inner electrode layer are squeezed out into the dielectric layer at the time of sintering the inner electrodes, such that the inhibitors having high sintering drivability are absorbed into the dielectric layers, thereby making the size of the dielectric grains large.

In detail, after being sintered, the size of the dielectric grains may be 1 to 1.3 times larger than that of the dielectric grains before being sintered. As the size of the dielectric grains of the dielectric layer is increased after being sintered, it is possible to maximize the capacity of the multilayered ceramic elements while maintaining the reliability thereof.

In addition, it can be appreciated that the dielectric grains configuring the dielectric layer according to the third exemplary embodiment of the present invention may be adjacent to each other in shapes other than the spherical shape, for example, a polygon, a diamond, a rectangle, a regular square, a triangle, a square, and the like. The shape of the dielectric grains 111 may use all the shapes other than a spherical shape having a round shape.

The average particle size of the dielectric grains configuring the dielectric layer is preferably 0.15 μm or less and when the average particle size of the dielectric grains exceeds 0.15 μm, there is a need to form the thick dielectric layer so as to increase the BDV of the multilayered ceramic element chips, which makes it difficult to manufacture the super-capacity chip.

Therefore, the inner electrode layers 120a and 120b according to the third exemplary embodiment of the present invention include the inhibitors in the amount of 3 to 12 wt % with respect to the weight of the metal powders, wherein the average particle size of the inhibitors has the size of about 30% with respect to the average particle size of the dielectric base metals included in the dielectric layer 110.

Therefore, in the case in which the inhibitors according to the exemplary embodiment of the present invention is less than 3 wt % with respect to the weight of the metal powders, the inhibitors have the multi-layer structure but are insufficient to make the size of the dielectric grains large. In addition, when the inhibitors exceeds 12 wt %, the dielectric grains positioned at the interface between the dielectric layer and the inner electrode layer are excessively grown or the thick dielectric layer is formed to degrade the reliability and the capacity, and the like, thereby causing the problem of implementing the chip characteristics.

In addition, when the average particle size of the inhibitors exceeds 30% with respect to the average particle size of the dielectric base metals included in the dielectric layer, it is not possible to control the shrinkage of the electrode with a small amount of inhibitors and thus, it is difficult to implement the high reliability.

As the dielectric components configuring the dielectric layer according to the third exemplary embodiment of the present invention, the barium titanate (BaTiO₃) may be used like the first exemplary embodiment of the present invention, as the metal powders of the inner electrode layer, nickel (Ni) or copper (Cu) may be used, and the inner electrode layer may have a thickness of 0.1 to 0.5 μm.

In addition, the inhibitors use the barium titanate (BaTiO₃) as main components and use a mixture of the metal oxides as accessory components. An example of metals of the metal oxides may include one or more lanthanide rare earth elements selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺.

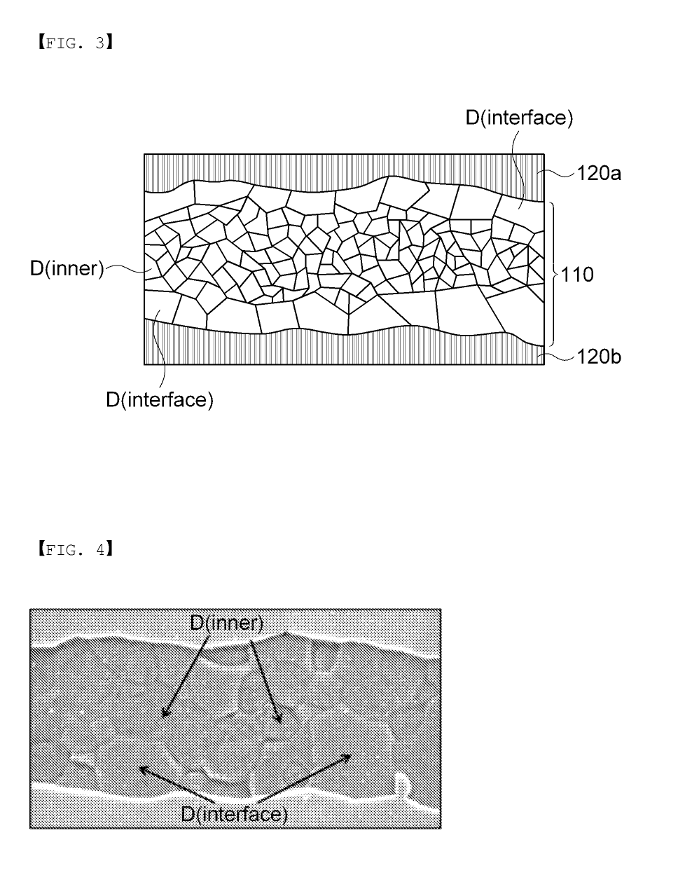

In addition, as shown in FIG. 3, the multilayered ceramic elements according to a fourth exemplary embodiment of the present invention have a structure in which the inner electrode layers 120a and 120b and the dielectric layer 110 are alternately multilayered, wherein the inner electrode layers 120a and the 120b include the inhibitors in the amount of 3 to 12 wt % with respect to the weight of the metal powders, the average particle size of the inhibitors has a size of about 30% with respect to the average particle size of the dielectric base metals included in the dielectric layer 110, the dielectric grains 111 of the dielectric layer 110 have the laminar structure, and an average particle size D (interface) of the dielectric grain positioned at the interface adjacent to the inner electrodes is larger than the average particle size D (inner) of the dielectric grain positioned in the dielectric layer in which the dielectric grains are adjacent to each other, rather than being adjacent to the inner electrode, in the dielectric grain 111 having the laminar structure.

According to the fourth exemplary embodiment of the present invention, as shown in FIG. 3, the dielectric grains 111 configuring the dielectric layer 110 have the multi-layer laminar structure by controlling the content and particle size of the inhibitors but in the dielectric grain 111 having the laminar structure, the average diameter D (interface) of the dielectric grain positioned at the interface adjacent to the inner electrodes is formed to be larger than the average particle size D (inner) of the dielectric grain positioned in the dielectric layer in which the dielectric grains are adjacent to each other, rather than being adjacent to the inner electrode, in the dielectric grain 111 having the laminar structure.

Even in the fourth exemplary embodiment of the present invention, the thickness of the dielectric layer 110 is thinly formed at 0.5 μm or less and the dielectric grains 111 configuring the same may have the laminar structure of the multi-layer, for example, two layers or more, preferably, 3 to 7 layers. The dielectric grains 111 have the multi-layer laminar structure, thereby improving the reliability characteristics of the multilayered ceramic elements.

In particular, as shown in FIG. 3, in the dielectric layer 110 according to the fourth exemplary embodiment of the present invention, it can be appreciated that the average particle size D (interface) of the dielectric grain positioned at the interface adjacent to the inner electrode is larger than the average particle size D (inner) of the dielectric grain positioned in the dielectric layer in which the dielectric grains are adjacent to each other, rather than being adjacent to the inner electrodes, in the dielectric grains 111 configuring the dielectric layer 110. Preferably, the dielectric grains 111 may be formed in the range in which the D (interface)/D (inner) satisfy 1.2 to 2.2. When the D (interface)/D (inner) are less than 1.2, it is difficult to manufacture the high-capacity chip. In addition, when the D (interface)/D (inner) exceed 2.2, the reliability may be deteriorated.

The average particle size of the dielectric grain 111 configuring the dielectric layer 110 according to the exemplary embodiment of the present invention is preferably 0.15 μm or less. When the average particle size of the dielectric grain exceeds 0.15 μm, it is difficult to manufacture the super-capacity chip due to the formation of the thick dielectric layer in order to increase the breakdown voltage (BDV) of the multilayered ceramic element chip.

In addition, as shown in FIG. 3, the dielectric grains 111 configuring the dielectric layer 110 may be adjacent to each other in shapes other than a spherical shape, for example, a polygon, a diamond, a rectangle, a regular square, a triangle, a square, and the like. The shape of the dielectric grains 111 may use all the shapes other than a spherical shape having a round shape.

In the fourth exemplary embodiment of the present invention, it is possible to differently control the sizes of the dielectric grains D (interface) at the interface of the dielectric layer 110 and the size of the dielectric grains D (inner) in the dielectric layer 110 by appropriately controlling the content and particle size of the inhibitors included in the inner electrode layers 120a and 120b.

Therefore, the inner electrode layers 120a and 120b according to the fourth exemplary embodiment of the present invention include the inhibitors in the amount of 3 to 12 wt % with respect to the weight of the metal powders, wherein the average particle size of the inhibitors has the size of about 30% with respect to the average particle size of the dielectric base metals included in the dielectric layer 110.

Therefore, when the inhibitors according to the exemplary embodiment of the present invention are 3 wt % with respect to the metal powders, the inhibitors have the multi-layer structure and the inhibitors are insufficient to control the size of the dielectric grains in the range in which the D (interface)/D (inner) satisfy 1.2 to 2.2. In addition, when the inhibitors are excessively added due to the excess of 12 wt %, the dielectric grain positioned at the interface between the dielectric layer and the inner electrode layer is excessively grown when being excessively added and the thick dielectric layer is formed to degrade the reliability and the capacity, thereby causing the problem of implementing the multilayered ceramic element chip characteristics.

In addition, when the average particle size of the inhibitors has a size exceeding 30% with respect to the average particle size of the dielectric base metals included in the dielectric layer, it is not possible to control the shrinkage of the electrode with a small amount of inhibitors and thus, it is difficult to implement the high reliability and when the inhibitors having the large particle size are used, it is not possible to more sufficiently promote the growth of the base metals than the particulate inhibitors due to the reduction in the sintering drivability and thus, it is difficult to implement the capacity.

As the dielectric components configuring the dielectric layer according to the fourth exemplary embodiment of the present invention, the barium titanate (BaTiO₃) may be used like the first exemplary embodiment of the present invention, as the metal powders of the inner electrode layer, nickel (Ni) or copper (Cu) may be used, and the inner electrode layer may have a thickness of 0.1 to 0.5 μm.

In addition, the inhibitors use the barium titanate (BaTiO₃) as main components and use a mixture of the metal oxides as accessory components. An example of metals of the metal oxides may include one or more lanthanide rare earth elements selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺.

Hereinafter, the exemplary embodiments of the present invention will be described in detail. The following examples are only for illustrating the present invention, and the scope of the present invention should not be interpreted as being limited by these examples. In addition, specific compounds are used in the following examples, but it is obvious to those skilled in the art that equivalents thereof can exhibit the same or similar degrees of effects.

### EXAMPLES AND COMPARATIVE EXAMPLES

As shown in the following Table 1, the multilayered electronic elements (MLCCs) were manufactured while changing each composition, the particle size, and the content. The super-capacity MLCC (the dielectric thickness is 0.5 μm or less and the inner electrode is 0.3 μm) was manufactured by using the metal powders of the inner electrode layer of the nickel metal and using the inhibitors including the barium titanate as the main component and the metal oxides as the accessory materials.

In addition, the capacity and reliability of the manufactured super-capacity MLCC were measured with the breakdown voltage (BDV) acceleration lifespan and the results were in the following Table 1.

TABLE 1

| | D(Inhibitor)/ | | | | |
|---|---|---|---|---|---|
| | D(Dielectric | Added | | | |
| | base metal of | quantity of | | | |
| Sample | dielectric | inhibitor | D(interface)/ | | |
| No. | layer) | (wt %/Ni) | D(inner) | Capacity | Reliability |
| 1* | 0.25~0.3 | 1 | 1.23 | ⊚ | X |
| 2* | 0.25~0.3 | 2 | 1.20 | ⊚ | X |
| 3* | 0.25~0.3 | 3 | 1.33 | ⊚ | X |
| 4 | 0.25~0.3 | 4 | 1.32 | ◯ | ◯ |
| 5 | 0.25~0.3 | 6 | 1.34 | ◯ | ◯ |
| 6 | 0.25~0.3 | 8 | 1.39 | ◯ | ◯ |
| 7 | 0.25~0.3 | 10 | 1.42 | ◯ | ◯ |
| 8 | 0.25~0.3 | 12 | 1.47 | ◯ | ◯ |
| 9* | 0.25~0.3 | 14 | 1.48 | X | ⊚ |
| 10* | 0.25~0.3 | 20 | 1.52 | X | ⊚ |
| 11* | 0.2~0.25 | 1 | 1.28 | ⊚ | X |
| 12 | 0.2~0.25 | 2 | 1.38 | ⊚ | ◯ |
| 13 | 0.2~0.25 | 3 | 1.39 | ⊚ | ◯ |
| 14 | 0.2~0.25 | 4 | 1.41 | ⊚ | ◯ |
| 15 | 0.2~0.25 | 6 | 1.58 | ◯ | ◯ |
| 16 | 0.2~0.25 | 8 | 1.57 | ◯ | ◯ |
| 17 | 0.2~0.25 | 10 | 1.65 | ◯ | ⊚ |
| 18 | 0.2~0.25 | 12 | 1.71 | ◯ | ⊚ |
| 19* | 0.2~0.25 | 14 | 1.77 | X | ⊚ |
| 20* | 0.2~0.25 | 20 | 1.89 | X | ⊚ |
| 21* | 0.1~0.2 | 1 | 1.58 | ⊚ | X |
| 22* | 0.1~0.2 | 2 | 1.61 | ⊚ | X |
| 23 | 0.1~0.2 | 3 | 1.68 | ⊚ | ◯ |
| 24 | 0.1~0.2 | 4 | 1.77 | ⊚ | ◯ |
| 25 | 0.1~0.2 | 6 | 1.86 | ⊚ | ◯ |
| 26 | 0.1~0.2 | 8 | 1.93 | ◯ | ⊚ |
| 27 | 0.1~0.2 | 10 | 1.96 | ◯ | ⊚ |
| 28 | 0.1~0.2 | 12 | 2.09 | ◯ | ⊚ |
| 29* | 0.1~0.2 | 14 | 2.06 | X | ⊚ |
| 30* | 0.1~0.2 | 20 | 2.18 | X | ⊚ |

Note 1)
*is out of a range of the present invention
Note 2)
X: Badness (75% or less), ◯: Good (75-85%), ⊚: Very good (85% or more)

As can be appreciated from the results of Table 1, when the average particle size of the inhibitors included in the inner electrode layer has the size within about 30% with respect to the average particle size of the dielectric base metals included in the dielectric layer and the added quantity of the inhibitors is included at 3 to 12 wt % with respect to the weight of the nickel metal powders, it makes the capacity and reliability excellent through the growth of the dielectric grain of the dielectric layer due to the high sintering drivability of the inhibitors that are squeezed out at the interface between the dielectric layer and the inner electrode layer.

In addition, as the result of confirming the capacity and reliability of the MLCC chip according to the particle size and content of the used inhibitors, as the particle size of the inhibitors is reduced, the effect of the capacity increase is remarkably shown. However, the content of the inhibitors exceeds 12 wt % with respect to the nickel metal powder, which results in reducing the capacity due to the excessive growth of dielectric layer. In addition, as the content of the inhibitors is increased, the reliability was highly observed, which shows more remarkably effect of the inhibitors having a small particle size.

In addition, referring to FIG. 4 after the dielectric layer of the super-capacity MLCC manufactured according to the exemplary embodiment of the present invention was measured using the FE-SEM, it can confirm that the dielectric grains are formed to have the multi-layer laminar structure of 3 to 7 layers in the dielectric layer. In the dielectric grains configuring the dielectric layer, it can be appreciated that the average particle size D (interface) of the dielectric grain positioned at the interface adjacent to the inner electrode in the dielectric grains is larger than the average particle size D (inner) of the dielectric grain positioned in the dielectric layer in which the dielectric grains are adjacent to each other, rather than being adjacent to the inner electrode.

In addition, as shown in FIG. 4, it can be appreciated that the dielectric grains configuring the super-capacity MLCC dielectric layer are adjacent to each other in various shapes rather than a spherical shape.

According to the exemplary embodiments of the present invention, it is possible to increase the capacity of the multilayered ceramic elements by controlling the particle size and the added quantity of the inhibitors included in the inner electrode layers that are squeezed out during the firing at high temperature.

In addition, according to the exemplary embodiments of the present invention, the dielectric layers of the multilayered ceramic elements are formed so that the dielectric grains included in the dielectric layers have the laminar structure, preferably, the structure of 3 to 7 layers even in a fine thickness of 0.5 μm or less, thereby making it possible to improve the reliability of the multilayered ceramic elements.

Further, according to the exemplary embodiments of the present invention, the dielectric grain sizes of the dielectric layers greatly affecting the electrical characteristics of the multilayered ceramic elements is controlled 1.3 times larger than before being sintered, thereby maximizing the capacity while maintaining the reliability of the multilayered ceramic elements.

Moreover, according to the exemplary embodiments of the present invention, it is possible to improve the reliability of the multilayered ceramic elements by controlling the dielectric grain size at the interface at which the dielectric layers contact the inner electrode layers in the dielectric layers in which the dielectric grains have the laminar structure so as to be larger than the grain size in the dielectric layers in which the dielectric grains contact each other.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. Multilayered ceramic elements having a structure in which an inner electrode layer and a dielectric layer are alternately multilayered, wherein
the inner electrode layer includes inhibitors in the amount of 3 to 12 wt % with respect to a weight of metal powders, and
an average particle size of the inhibitors has a size of about 30% with respect to an average particle size of dielectric base metals included in the dielectric layer.

2. Multilayered ceramic elements having a structure in which an inner electrode layer and a dielectric layer are alternately multilayered, wherein
the inner electrode layer includes inhibitors in the amount of 3 to 12 wt % with respect to a weight of metal powders,
an average particle size of the inhibitors has a size of about 30% with respect to an average particle size of dielectric base metals included in the dielectric layer, and
dielectric grains of the dielectric layer have a laminar structure.

3. Multilayered ceramic elements having a structure in which an inner electrode layer and a dielectric layer are alternately multilayered, wherein
the inner electrode layer includes inhibitors in the amount of 3 to 12 wt % with respect to a weight of metal powders,
an average particle size of the inhibitors has a size of about 30% with respect to an average particle size of dielectric base metals included in the dielectric layer,
dielectric grains of the dielectric layer have a laminar structure, and
sizes of the dielectric grains are different from each other after and before being sintered.

4. The multilayered ceramic elements according to claim 3, wherein the size of the dielectric grains after being sintered is 1 to 1.3 times larger than the size of the dielectric grains before being sintered.

5. Multilayered ceramic elements having a structure in which an inner electrode layer and a dielectric layer are alternately multilayered, wherein
the inner electrode layer includes inhibitors in the amount of 3 to 12 wt % with respect to a weight of metal powders,
an average particle size of the inhibitors has a size of about 30% with respect to an average particle size of dielectric base metals included in the dielectric layer,
dielectric grains of the dielectric layer have a laminar structure, and
in a dielectric grain having the laminar structure, an average particle size D (interface) of the dielectric grain positioned at an interface adjacent to an inner electrode is larger than an average grain size D (inner) of the dielectric grain positioned in the dielectric layer in which the dielectric grains are adjacent to each other, rather than being adjacent to the inner electrode.

6. The multilayered ceramic elements according to claim 5, wherein the D (interface)/D (inner) satisfy 1.2 to 2.2.

7. The multilayered ceramic elements according to any one of claims 1 to 3 and 5, wherein a thickness of the dielectric layer is 0.5 μm or less.

8. The multilayered ceramic elements according to any one of claims 1 to 3 and 5, wherein the average particle size of the dielectric grain is 0.15 μm or less.

9. The multilayered ceramic elements according to any one of claims 2, 3, and 5, wherein the dielectric layer has a laminar structure of 3 to 7 layers.

10. The multilayered ceramic elements according to any one of claims 2, 3, and 5, wherein the dielectric grains are adjacent to each other in other shapes other than a spherical shape.

11. The multilayered ceramic elements according to any one of claims 1 to 3 and 5, wherein the inner electrode layer has a thickness of 0.1 to 0.5 μm.

12. The multilayered ceramic elements according to any one of claims 1 to 3 and 5, wherein the inner electrode is made of nickel (Ni) or copper (Cu).

13. The multilayered ceramic elements according to any one of claims 1 to 3 and 5, wherein the inhibitors include barium titanate (BaTiO3) and metal oxides.

14. The multilayered ceramic elements according to claim 13, wherein metals of the metal oxides are one or more lanthanide rare earth elements selected from a group consisting of Y³⁺, La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺.
